(19) United States
(12) Patent Application Publication
(10) Pub. No.: US 2018/0297088 A1
(43) Pub. Date: Oct. 18, 2018

(54) Lint Removal System

(71) Applicant: Douglas Lindstrand, Richmond, IN (US)

(72) Inventor: Douglas Lindstrand, Richmond, IN (US)

(21) Appl. No.: 15/680,442

(22) Filed: Aug. 18, 2017

Related U.S. Application Data
(60) Provisional application No. 62/485,591, filed on Apr. 14, 2017.

(51) Int. Cl. B08B 9/035; D06F 58/22; B08B 5/04

(52) U.S. Cl. CPC B08B 9/035; B08B 2203/0247; B08B 5/04; D06F 58/22

(57) ABSTRACT

The current invention is a dryer lint removal system and device that is easily and safe to use. It has a 4 inch elbow that connects to the dryer and is connected to a 4 duct tee. The duct tee is connected to a draft blocker, a flex hose and then to a blowout nozzle. The other side of the tee is connected to a standard exhaust hose. A blower is inserted into the blowout nozzle creating a strong air flow, along with the dryer airflow, pulls the lint from the dryer and also out of the exhaust duct works.

### CROSS-REFERENCES TO RELATED APPLICATIONS (IF ANY)

This application is the non-provisional application claiming the priority date of provisional application 62/485,591 filed Apr. 14, 2017.

### BACKGROUND

### 1. Field of the Invention

The present invention generally relates to lint removal. More specifically, the present invention is a lint removal system that provides a simple and easy way to clean out clothes dryer lint without having to move the dryer or any other appliance to get access.

### 2. Description of Prior Art

The act of washing and drying clothes is one of the essential tasks that an individual usually completes fairly often. There are a number of existing problems that exist during the task of drying, specifically with an obstructed or clogged clothes dryer exhaust:

1. Lint can back up into the clothes dryer, get on electrical connections and cause a fire, there are 16,000 house fires a year cause by lint in the USA.

2. Longer drying times, excessive lint in a dryer's exhaust will increase drying time by as much as more than an hour. Longer drying times causes increased power usage and more of a carbon footprint negatively impacting the environment.

3. Longer drying times causes increased power usage and more of a carbon footprint harming the atmosphere. (Also increasing electrical cost.)

4. Shorter dryer life due to having to work longer and harder per load of clothes.

5. Existing clean out methods to clean a dry exhaust requires the pulling out the dryer to get access to the hoses, even sometimes having to move the washer to get access.

6. The lifting heavy appliances can damage floor surfaces.

There is still room for improvement in the art.

### SUMMARY OF THE INVENTION

The current invention is a dryer lint removal system and device that is easily and safe to use.

A 4 elbow connects to the dryer and is connected to a 4 duct tee. The duct tee is connected to a draft blocker, a flex hose and then to a blowout nozzle. The other side of the tee is connected to a standard exhaust hose. A blower is placed into the blowout nozzle creating a strong air flow when in clean mode.

The air flow pulls the lint from the dryer also so that it can be discarded.

### BRIEF DESCRIPTION OF THE DRAWINGS

Without restricting the full scope of this invention, the preferred form of this invention is illustrated in the following drawings:

FIG. 1 is a perspective view drawing of the present invention and its components in a preferred embodiment;

FIG. 2 is a perspective view drawing of the present invention and its components in a preferred embodiment using the opposite direction;

FIG. 3 shows an open elbow; and

FIG. 4 shows airflow going through the tee.

### DESCRIPTION OF THE PREFERRED EMBODIMENT

There are a number of significant design features and improvements incorporated within the invention.

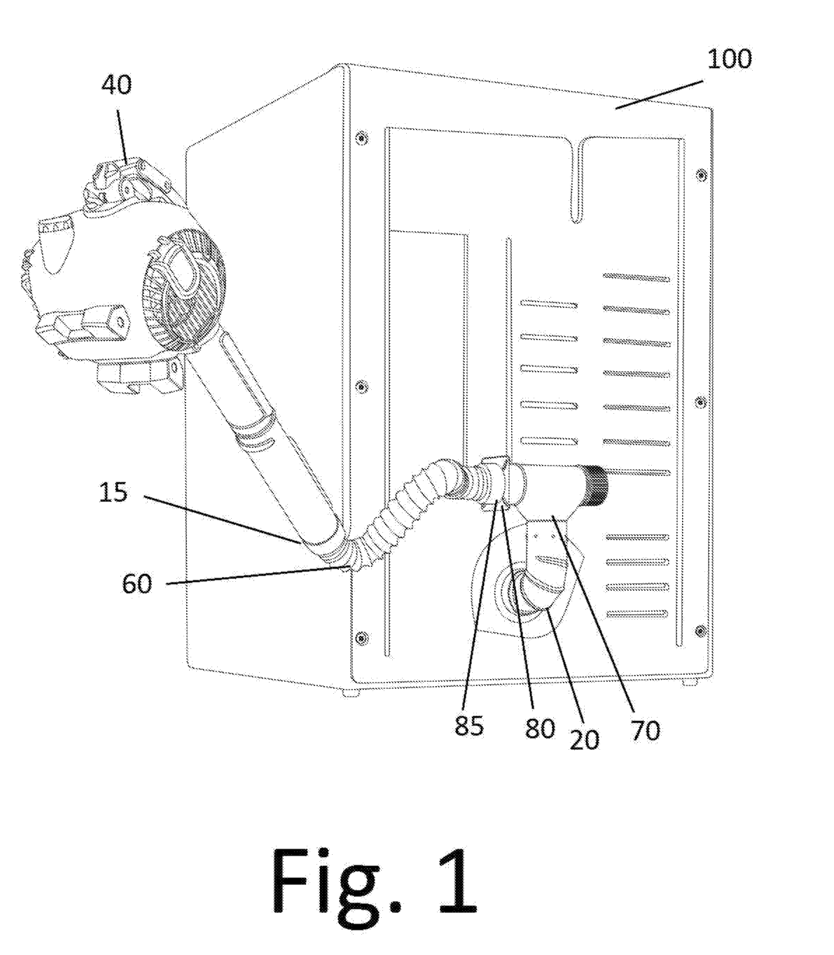

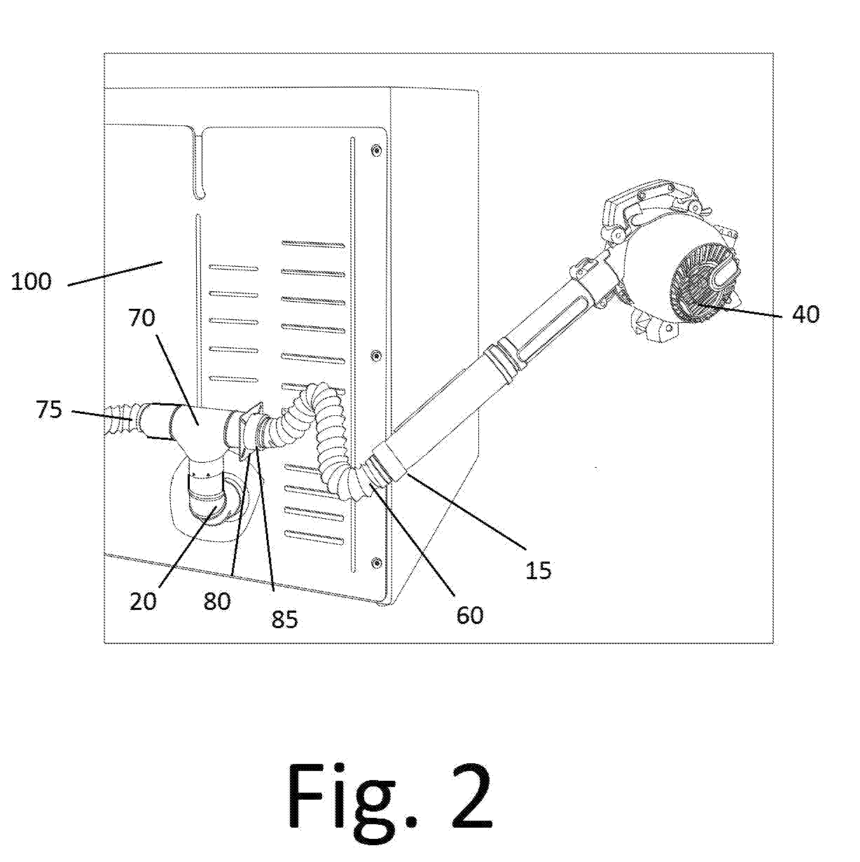

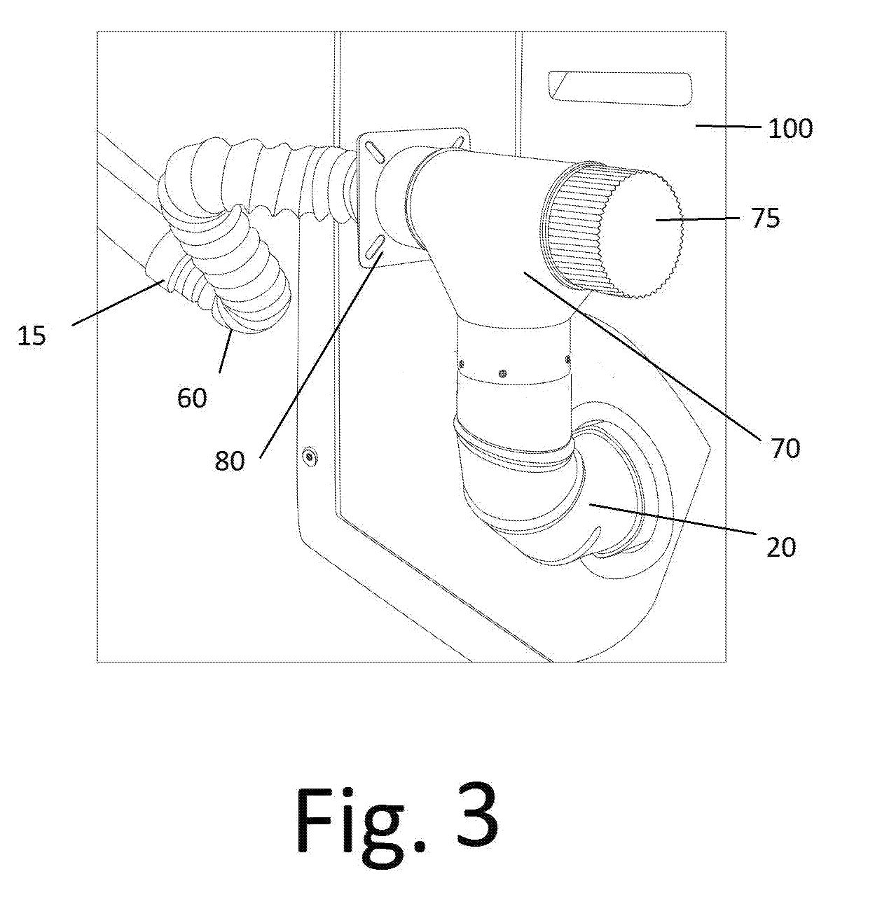

As shown in FIGS. 1 through 4, the current invention is a dryer lint removal system and device that is easily and safe to use. The present invention gives an easy way to clean out clothes dryer lint without having to move the dryer 100.

All clothes dryers 100 have the same exhaust ports 10 at the bottom rear of the dryer 100, a 4″ air duct, so this invention will mount to all dryers 100 without modifications.

A 4′ elbow 20 connects to the dryer 100 and is connected to a 4″ duct tee 70. On one side of the tee is a standard draft blocker 80 that allows one-way air flow. The blocker 80 is attached to a reducer 85 and then a 3″ flex hose 60 and then to a blowout nozzle 15.

The other side of the 4″ tee 70 is connected to a standard 4′ aluminum flex dryer exhaust hose 75. The exhaust hose 75 is connected to a wall vent that goes through a wall carrying the lint 90 out of the dryer 100 and out of the dwelling.

### Operation

The dryer 100 is used normally in drying mode. When it is time to clean out the lint 90 out of the vent, the empty dryer 100 is turned on.

An airflow generator 40 is placed at the blow out nozzle 50. The airflow generator 40 generates an airflow of 150 mph. It can be any standard blower such as a leaf blower. The air will flow down a flex hose 60 through the 4″ draft blocker 70.

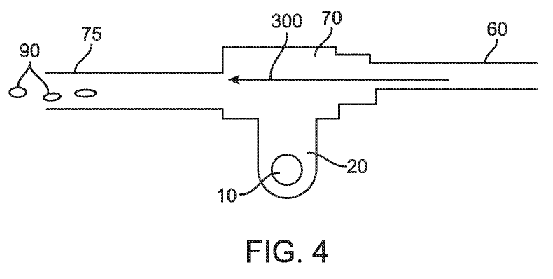

The draft blocker flapper 80 will open and the combination of the high-speed blower air 200 and the dryer exhaust will blast out the lint 90 from the system. As the high-speed air 300 goes thru the tee it creates a vacuum and pulls lint 90 from the dryer 100 too as shown in FIG. 4.

The draft blocker 80 prevents air from going up the 3′ flex hose 60 when the dryer 100 is in normal drying mode. Clean out time is less than ten seconds, then remove the blower 40 and place the blow out nozzle 15 in its holder 5 behind the dryer 100. The blow out nozzle 15 is designed to extend out of the flex hose 60 for use. It has a nozzle 15 that fits the end of the blower 40.

The clean out intervals should be between 2 and 3 months. Lint 90 clean out is now fast and simple through the present invention.

The system can also be designed with the blower 40 permanently attached to the end of the flex hose 60 and turned on when needed.

### Advantage

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device to remove lint from a dryer comprising:
An elbow connected to the dryer exhaust, a tee connected to the elbow with the tee have two ends, having a draft blocker attached to the tee with a flexible hose connected to the draft blocker with a blower nozzle connected to the flexible hose and having a exhaust hose connected to the other end of the tee.

2. A device according to claim 1 comprising:
Having a blower connected to the blower nozzle.

3. A device according to claim 2 comprising:
Where the blower generate air flow.

4. A device according to claim 3 comprising:
Having the air flow through the flexible hose, through the draft blocker, through the tee and out the exhaust hose.

5. A device according to claim 1 comprising:
Having a blower inserted into the blower nozzle. 6. A device according to claim 1 comprising:
Having a draft blocker between the flexible hose and the tee.

7. A device according to claim 6 comprising:
Having the exhaust hose connect to an exhaust vent.

8. A device according to claim 2 comprising:
Where the air blower is permanently attached to the blower nozzle.

9. A device according to claim 2 comprising:
Where the air blower is not permanently attached to the blower nozzle.

10. A process to remove lint from a dryer comprising:
Having an elbow connected to the dryer exhaust, having a tee connected to the elbow, having the tee have two ends, having a draft blocker attached to one end of the tee, having a flexible hose connected to the draft blocker and having a blower nozzle connected to the flexible hose, having an exhaust hose connected to the other end of the tee, generating air flow and having the air flow go into the blower nozzle generating an vacuum in the tee pulling the lent out of the dryer.

11. A process according to claim 10 comprising:
Having a blower connected to the blower nozzle.

12. A process according to claim 11 comprising:
Having the blower generate the air flow.

13. A process according to claim 12 comprising:
Having the air flow through the flexible hose , through the draft blocker, through the tee and out the exhaust hose.

14. A process according to claim 10 comprising:
Having a draft blocker between the flexible hose and the tee.

15. A process according to claim 10 comprising:
Having a blower inserted into the blower nozzle. 16. A process according to claim 15 comprising:
Having the exhaust hose connect to an exhaust vent.

17. A process according to claim 11 comprising:
Having the air blower permanently attached to the blower nozzle.

18. A process according to claim 11 comprising:
having the air blower not be permanently attached to the blower nozzle.
